(19) United States
(12) Patent Application Publication
(10) Pub. No.: US 2008/0216710 A1
(43) Pub. Date: Sep. 11, 2008

(54) Method of Processing Mica

(75) Inventors: Dean Beam, Bakersville, NC (US); Eddie Duncan, Bakersville, NC (US); John Zarichansky, Newville, PA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Kentucky-Tennessee Clay Co., Nashville, TN (US)

(21) Appl. No.: 11/575,507

(22) PCT Filed: Sep. 23, 2005
(86) PCT No.: PCT/US2005/033921

§ 371 Date: Dec. 20, 2007

Related U.S. Application Data
(60) Provisional application No. 60/612,798, filed on Sep. 27, 2004.

(51) Int. Cl. C09C 1/40; C08K 3/34; C04B 14/20; B02C 15/00

(52) U.S. Cl. 106/417; 241/24.1; 241/27; 241/23; 524/449

(57) ABSTRACT

Disclosed are methods of processing mica, compositions resulting from these methods, and paints comprising the mica. One method relates to a method of processing mica comprising dry attrition grinding a micaceous material to produce a micaceous product having a particle size distribution such that at least about 60% by weight of the micaceous product passes through a 325 mesh screen. The dry grinding can be performed with at least one non-mica grinding media, such as a ceramic ball mill. The methods described herein can use mica from the Spruce Pine Mining District of North Carolina. The methods can allow the use of micaceous materials having a wide range of grit content with minimal adverse effect on the brightness.

This application claims priority to U.S. Provisional Patent Application No. 60/612,798, filed Sep. 27, 2004.

Disclosed herein are methods for processing mica or micaceous materials recovered as a by-product from feldspar production, and products thereof.

Mica is often ground both to delaminate it, and to produce a finer, lower-grit, easily dispersible product. Previously, mica grinding had often been accomplished with fluid energy mills, also known as jet mills. Fluid energy mills have been primarily used for grinding mica because of the low initial capital expense required to purchase them. Fluid energy mills operate by injecting jets of a gas (usually air or steam) at multiple points around the periphery of a disc shaped chamber to set up a vortex type flow pattern. The particles to be milled are then introduced near the periphery of this disc and are quickly accelerated to a high velocity. The grinding occurs via high speed interparticle collisions. Unlike some other forms of grinding, jet milling does not require the presence of a separate grinding media.

Fluid energy mills, however, can have undesirable effects on mica, resulting in a less bright color and in some cases rendering the mica hydrophobic, which makes the mica unsuitable for use in some applications, such as in aqueous based paints.

While not wishing to be bound by any theory, it is hypothesized that grinding mica with an additional grinding media shears the mica plates with a smaller amount of interplate edge to edge collision than is seen with the more common fluid energy-milling. Interplate collision apparently roughens the plate edges, which makes the plates more hydrophobic and may reduce brightness. The hydrophobicity can be avoided by media grinding. Further, it is even possible in some cases to reverse the hydrophobicity by dry media grinding a previously hydrophobic, fluid energy-milled mica. Presumably, the media grinding serves to smooth out the roughened edges of the damaged mica flakes. The resultant non-hydrophobic media milled mica is likely to be useful in applications such as aqueous paints.

Accordingly, there remains a need to develop a method for refining mica or making mica-containing materials (referred to as “micaceous material”), such as finer mica, that avoids the use of jet milling processes.

One aspect of the present disclosure provides a method of processing mica or making mica-containing materials, comprising:

dry attrition grinding a micaceous material to produce a micaceous product having a particle size distribution such that at least about 60% by weight of the micaceous product passes through a 325 mesh screen.

In one aspect, the mica is obtained from the Spruce Pine Mining District of Avery, Mitchell, and Yancey counties, North Carolina (“Spruce Pine mica”). The Spruce Pine area is the major feldspar production center in North America and includes substantial deposits of alaskite, an igneous, granitic rock that is composed mainly of feldspar, quartz and mica. Thus, the feldspar tailings include a substantial portion of mica, such as muscovite mica, some of which can be recovered and sold as a product in its own right. Typically, the alaskite is ground and the mica and quartz are separated from the feldspar by flotation, such as by chemical flotation or by oil flotation. Another source of mica is pegmatite.

### BRIEF DESCRIPTION OF THE DRAWINGS

FIG. 1 is a scanning electron microscopy (SEM) photograph of a prior art jet-milled micaceous sample at 220× magnification;

FIG. 2 is an SEM photograph of a prior art jet-milled micaceous sample at 450× magnification;

FIG. 3 is an SEM photograph of an inventive ball-milled micaceous sample at 220× magnification; and

FIG. 4 is an SEM photograph of an inventive ball-milled micaceous sample at 450× magnification.

As used herein, “micaceous material” refers to a material containing at least some mica. For example, in one aspect, the micaceous material comprises mica obtained from the Spruce Pine area and can be still present in either alaskite or pegmatite. For example, the alaskite or pegmatite can be dry ground, followed by deriving the mica from the alaskite or pegmatite, such as by a flotation process, e.g., oil flotation.

In another aspect, the micaceous material has been derived from alaskite or pegmatite. In one aspect, when the micaceous material is derived from alaskite, the mica is obtained by separating the mica from feldspar by flotation, such as by oil flotation.

“Dry” as used herein refers to a water content of no more than about 5% by weight relative to the total weight of the mineral that is ground, such as a water content of no more than about 3% by weight or no more than about 1% by weight.

In one aspect, the micaceous material is dried prior to the grinding. The drying can be performed by air drying or by subjecting the mica to a heat treatment. In one aspect, drying comprises heating the micaceous material at a temperature of at least about 35° C. (product temperature). In another aspect, the drying comprises heating the micaceous material at a temperature ranging from about 35° C. to about 150° C., such as a temperature ranging from about 35° C. to about 125° C. The heating can be performed by any method known in the art, such as by heating with a fluid bed dryer. In one embodiment, the drying and grinding occur simultaneously.

In one aspect, the grinding comprises grinding with at least one non-mica grinding media, as opposed to jet milling in which the mica particles collide against one another to cause the grinding. In one aspect, the grinding is performed by at least one process chosen from mill grinding and mortar and pestle grinding. In one aspect, the grinding is performed by mill grinding. Any mill known in the art for grinding or comminuting minerals can be used. For example, a ball mill can be used in which the mica, alaskite, or pegmatite is placed in a cylindrical tube mill or drum mill containing ball grinding media. For example, the ball grinding media can be non-metallic media. In one aspect, the non-metallic media mill comprises ceramic media. Other media include plastics and rubber. In one aspect, the at least one non-mica media is a mortar and pestle.

In another aspect, the dry grinding comprises attrition grinding. “Attrition grinding” as used herein refers to a process of wearing down particle surfaces resulting from grinding and shearing stress of the particles between the moving grinding particles. Attrition can be accomplished by rubbing particles together under pressure. Thus, attrition grinding excludes jet milling processes, in which the particles collide under high impact conditions.

In one aspect, after the grinding, the micaceous product has a particle size distribution such that at least about 70% by weight of the micaceous product passes through a 325 mesh screen. In another aspect, at least about 80% by weight or at least about 90% by weight of the micaceous product passes through a 325 mesh screen after the grinding. A 325 mesh screen has holes equivalent to a particle diameter of about 44 μm.

In one aspect, the micaceous product has a small amount of oversize contamination, e.g., a small amount of mica that cannot pass through a 325 mesh screen. Oversize contamination can cause streaking in coating products that incorporate the ground mica. The traditional jet milling process, which uses a high energy impact mill, can inherently produce a larger amount of oversize contamination because a minimum level of feldspar and/or quartz grit is usually needed to act as a grinding aid. In contrast, a ball mill, which grinds by attrition, does not require this grit for effective grinding. Even if the micaceous material contained a high grit content, the ball milling can grind grit effectively and reduce the grit size. Thus, ball milling can control oversize contamination to allow the use of a micaceous material having a wide range of grit content. As long as grit size is controlled in the final micaceous product it can be used in most products as filler, potentially with little to no adverse affect.

In one aspect, after the grinding, the micaceous product has a particle size distribution containing less than about 5% by weight +100 mesh oversize, or 3.5% by weight +100 mesh oversize, e.g., less than about 3.5% by weight of the micaceous product is retained on a 100 mesh screen. Alternatively, the micaceous product can be passed through another screen to minimize or even lessen the amount of +100 mesh grit.

In one aspect, after the grinding, the micaceous product is hydrophilic. As discussed above, jet milling can create a roughened surface with feathered edges, which can make the final ground product hydrophobic when placed into water. A ball milled micaceous product is smoother by comparison and the product is hydrophilic when placed into water. A hydrophilic surface can make the ball milled product easier to suspend, which can be useful for preparing stable slurries or aqueous-based suspensions.

In one aspect, the micaceous product has an increased GE brightness compared to the micaceous material prior to the grinding. A product ground by the process described herein can be brighter than a jet milled product, which is a useful feature for surface coatings. The method for measuring GE brightness is reproducible and permits relative comparison of the brightness of one sample to another. In one aspect, after the grinding the micaceous product has a GE brightness of at least about 60, such as a GE brightness of at least about 65.

In one aspect, after grinding, the micaceous product has a grit content ranging from about 0.1% to about 50% by weight, relative to the total weight of the micaceous product. The dry grinding method described herein allows the presence of a relatively large amount of grit in the grinder feed. The effect of oversize grit particles in the grinder feed is minimized because the grit is also subject to grinding. In contrast, use of a jet mill would typically not significantly grind the grit and would likely result in the presence of an undesirable amount of oversize grit in the resulting jet milled product. In another aspect, the micaceous product has a grit content ranging from about 25% to about 50% by weight, relative to the total weight of the micaceous product.

In one aspect, the micaceous material is a jet milled mica. As described herein, jet milled mica is disadvantageous in that a hydrophobic product is formed. It has been discovered that dry grinding the jet milled mica by any grinding method described herein can restore the hydrophilicity of the mica. In another aspect, dry grinding the jet milled mica results in a brighter product having a GE brightness of at least about 60.

Another aspect provides a composition comprising a hydrophilic, dry-ground micaceous product having a particle size distribution such that 80% by weight of the micaceous product passes through a 325 mesh screen. Yet another aspect provides a composition comprising dry-ground Spruce Pine mica having a GE brightness of at least about 60.

Another aspect provides an aqueous-based paint comprising the micaceous products prepared by the methods disclosed herein. Paint compositions comprising mica can optionally include at least one ingredient chosen from thickeners, dispersants, and biocides. The paint can also comprise at least one additional ingredient chosen from a polymeric binder, a primary pigment such as titanium dioxide, a secondary pigment such as calcium carbonate, silica, nepheline syenite, feldspar, dolomite, diatomaceous earth, and flux-calcined diatomaceous earth. For aqueous-based paint compositions, any water-dispersible binder, such as polyvinyl alcohol (PVA) and acrylics may be used. Paint compositions disclosed herein may also comprise other conventional additives, including, but not limited to, surfactants, thickeners, defoamers, wetting agents, dispersants, solvents, and coalescents.

The disclosure will be further clarified by the following non-limiting examples, which are intended to be purely exemplary of the invention.

### EXAMPLES

These Examples provide comparative experiments of the effect of heat treatment, grit content, and type of milling process on brightness and hydrophobicity of dry ground mica. For example, samples of mica ground in jet mills were compared versus mica ground with a ball mill. From these comparative experiments, it was observed that brightness was affected by grit content, particle size and milling type.

Five types of micaceous materials were tested in the Examples below, either “as is” or after being subjected to various processes:

USG: The USG sample of dry ground mica, which contains largely muscovite mica, was prepared by drying mica feed in a tube furnace, followed by milling the product in a fluid energy mill (Majac jet mill, Majac Tooling Supply Ltd., Barrie, Ontario).

AMC: Ashville mica, which contains largely muscovite mica, was obtained by milling with a Majac jet mill. The mica feed was not dried prior to milling.

Ball mill: This sample was obtained from Kentucky-Tennessee Clay Co. (“KT”) and contains largely muscovite mica. The mica feed was dried in a fluid bed drier prior to ball milling in closed circuit with an air classifier. The ball mill used was a 7 ft by 13 ft cylindrical tube mill, lined with a 6 inch natural stone liner, filled to a level of 42% by volume with 1¼ inch porcelain cylindrical shaped grinding media, and rotated by a 250 hp motor at a speed of 22.5 RPM. The mill as fed by a screw conveyor was equipped with a variable speed drive for feed control. Ground product exited the mill through a center discharge grate (the grate keeps the balls in the mill) where it dropped into a 24 inch square air chute (duct work). A system fan provided the necessary air volume to the product chute to carry all of the mill discharge to the Gyrotor air classifier. Thus, the conveyance system was actually air swept. The Gyrotor air classifier separated the fine product from the coarse oversize. The fines were collected in a cyclone and coarse oversize was returned to the feed end of the mill for regrinding along with fresh feed.

Unmilled: A sample of damp mica containing largely muscovite mica was obtained from the Spruce Pine feldspar mine.

Biotite: A sample of dark mica containing predominately biotite was obtained from the Spruce Pine feldspar mine.

### Example 1

### Milling and Particle Size Effect on Brightness

This Example describes experiments to determine the influence of the type of milling process and the particle size on brightness.

GE brightness was measured with a Minolta CR-200b Chroma Meter calibrated for measuring chromaticity and percent reflectance against a standardized white plate in the Yxy mode.

Hydrophobicity was determined from a wetting test, where a small amount of a mica sample was sprinkled over the surface of cold tap water. A hydrophobic product laid on the surface and did not enter into suspension even with aggressive agitation. A hydrophilic product wetted easily and dropped into suspension with little or no agitation.

Table I shows brightness and hydrophobicity data for various mica samples. Sample 1 is a USG sample as is. Sample 2 was prepared by grinding 5 to 7 g of the USG sample with a porcelain mortar of product until visible grit was eliminated. Likewise, Samples 3 and 4 were obtained with the AMC product as is and with mortar and pestle grinding, respectively. Samples 8 and 9 were obtained by heat treating the “Unmilled” mica samples. The heat treatment involved drying 20 g of damp sample in a muffle furnace for 2 hours at 100° C. Sample 9 was ground with a mortar and pestle, as described above. Samples 12 and 13 contained mica that was air dried prior to mortar and pestle grinding. Sample 13 was ground twice. Air dried samples were prepared by laying out a thin layer of product on a mat overnight.

TABLE I
Milling Effect on Brightness

| | | | | | | Hydro- |
|---|---|---|---|---|---|---|
| Sample | Sample | Dry | Grit | | Bright- | phobic |
| No. | Description | Method | Percent | APS* | ness | Yes/No |
| 1 | USG Jet Mill | Tube | Unknown | 19.32 | 60.0 | Yes |
| | as is | Furnace | | | | |
| 2 | USG Jet Mill | Tube | Unknown | | 67.1 | No |
| | mortar/pestle | Furnace | | | | |
| 3 | AMC Jet Mill | None | Unknown | 12.09 | 60.0 | Yes |
| | as is | | | | | |
| 4 | AMC Jet Mill | None | Unknown | | 62.2 | No |
| | mortar/pestle | | | | | |
| 8 | Unmilled | 100° C. | 0 | | 39.6 | No |
| | as is | | | | | |
| 9 | Unmilled | 100° C. | 0 | | 55.5 | No |
| | mortar/pestle | | | | | |
| 12 | Unmilled | Air | 50 | | 58.6 | No |
| | mortar/pestle | | | | | |
| 13 | Unmilled | Air | 50 | | 60.6 | No |
| | mortar/pestle | | | | | |
| | (Twice) | | | | | |

*Average Particle Size

The average particle size (APS) of a 4.0 g mica sample containing 50 mL of 0.05% sodium metaphosphate was measured with a Micromeritics 5100. The sodium metaphosphate was used as a surfactant to separate the particles for analysis. The data was indicated as cumulative percent finer. For example, APS defined 50% finer than a certain micron size.

For each pair of groupings (Samples 1 and 2, Samples 3 and 4, Samples 8 and 9) brightness increased after grinding with the mortar and pestle (or extra grinding in the case of Samples 12 and 13). Grinding with the mortar and pestle was similar to ball milling because the primary mechanism of comminution in both cases was attrition. Heat treating the mica also appeared to increase brightness as long as the treatment was performed prior to milling and at a temperature below the point where the mica turned brown.

Table II shows the effect of particle size on brightness for ball milled mica. Sample 5 is the Ball Mill sample as is, whereas Sample 6 was prepared by grinding the Ball Mill sample with a mortar and pestle, as described above. Sample 7 was prepared by grinding the Ball Mill sample with an automatic agate mortar and pestle. Because the mortar and pestle does not affect brightness on a ball milled product, the grinding mechanism for ball milling and mortar and pestle was likely the same.

TABLE II
Particle Size Effect on Brightness

| | | | | | | Hydro- |
|---|---|---|---|---|---|---|
| Sample | Sample | Dry | Grit | | Bright- | phobic |
| ID No. | Description | Method | Percent | APS | ness | Yes/No |
| 5 | Ball Mill | Fluid | 23 | 13.92 | 66.6 | No |
| | as is | Bed | | | | |
| | | Drier | | | | |
| 6 | Ball mill | Fluid | 23 | | 66.5 | No |
| | mortar/pestle | Bed | | | | |
| | | Drier | | | | |
| 7 | Ball Mill auto | Fluid | 23 | 10.7 | 66.5 | No |
| | agate* | Bed | | | | |
| | | Drier | | | | |

*An auto agate mill is an automatic grinding mortar and pestle device that is lined with agate. This mill can eliminate the possibility of contamination either by metal or ceramic during the grinding procedure. Agate is essentially inert to the grinding procedure.

Sample 5 was 80% by weight finer than 325 mesh and contained less than 3.5% by weight +100 mesh oversize. This size compared favorably with typical dry ground mica, milled in a Majac jet mill, such as Sample 1, which is only 60% by weight finer than 325 mesh and contains over 6% by weight +100 mesh oversize. Oversize contamination can be disadvantageous in that it can cause streaking in coating products incorporating the ground mica.

Grinding unmilled mica by ball milling or with a mortar and pestle can increase brightness by 30% to 40%. In comparing the GE brightness of Sample 5 (66.6) with Sample 1 (60), the ball milled mica is 11% brighter than the jet milled product.

From the data of Table II, it can be seen that the brightness of ball milled product did not improve with additional grinding. Despite the finer size of the APS of the AMC product (Sample 3) compared to the ball milled product (Sample 5), the ball milled product was considerably brighter than the AMC product. Thus, reducing APS alone does not necessarily cause an increase in brightness.

### Example 2

### Grit Content Effect on Brightness

In this Example, the brightness of samples of pure grit free mica was compared with the brightness of samples containing 50% by weight grit.

Pairs of samples were tested to determine the effect of feldspar grit content on brightness. Each pair was heat treated by a different method, either by air drying (Samples 11 and 12), drying in a muffle furnace (Samples 9 and 10), or drying on a hot plate (Samples 16 and 17), depending on the desired method of heat treating. The dried samples were then processed to separate the mica from the grit. The separation was performed with a magnetic barrier device (Frantz®) that separates magnetic particles from non-magnetic particles (S.G. Frantz, Co., Inc.). This device is a very powerful electromagnet that will attract mildly magnetic particles.

For each heat treatment method, the sample pair was compared with one another where one sample contained 0% by weight grit and the other contained 50% by weight grit. The Frantze magnetic device was used to test the grit values.

Table III shows the effect of grit content on brightness.

TABLE III
Grit Content Effect on Brightness

| | | | | | | Hydro- |
|---|---|---|---|---|---|---|
| Sample | Sample | Dry | Grit | | Bright- | phobic |
| No. | Description | Method | Percent | APS | ness | Yes/No |
| 9 | Unmilled | 100° C. | 0 | | 55.5 | No |
| | mortar/pestle | | | | | |
| 10 | Unmilled | 100° C. | 50 | | 63.0 | No |
| | mortar/pestle | | | | | |
| 11 | Unmilled | Air | 0 | | 52.1 | No |
| | mortar/pestle | | | | | |
| 12 | Unmilled | Air | 50 | | 58.6 | No |
| | mortar/pestle | | | | | |
| 16 | Biotite Mica | Hot | 0 | | 42.0 | No |
| | mortar/pestle | Plate | | | | |
| 17 | Biotite Mica | Hot | 50 | | 45.6 | No |
| | mortar/pestle | Plate | | | | |

Based on the data of Table III, it can be seen that the addition of 50% by weight grit to mica increased brightness regardless of the method of drying (heat treating). For example, mica that contained 50% by weight grit was 13% brighter than pure mica. The Biotite mica was considerably less bright than the muscovite mica of Samples 9-12. The grit had less of an effect on increasing brightness for the Biotite mica.

### Example 3

### Hydrophobicity

This Example describes experiments to determine the effect of hydrophobicity on brightness.

Because the grinding mechanism differs between jet mills and ball mills, it had been theorized that jet milling caused ground mica to become hydrophobic. The jet mill is a high energy single impact device that tends to create surface roughness and possibly even feathering of crystal edges. Increased surface roughness tends to increase surface tension, as evidenced when the ground mineral is placed in water. The primary grinding mechanism in ball mill is attrition, which does not necessarily roughen the surface. A mortar and pestle burnishes the rough surface of jet milled product with a milling action similar to the ball mill.

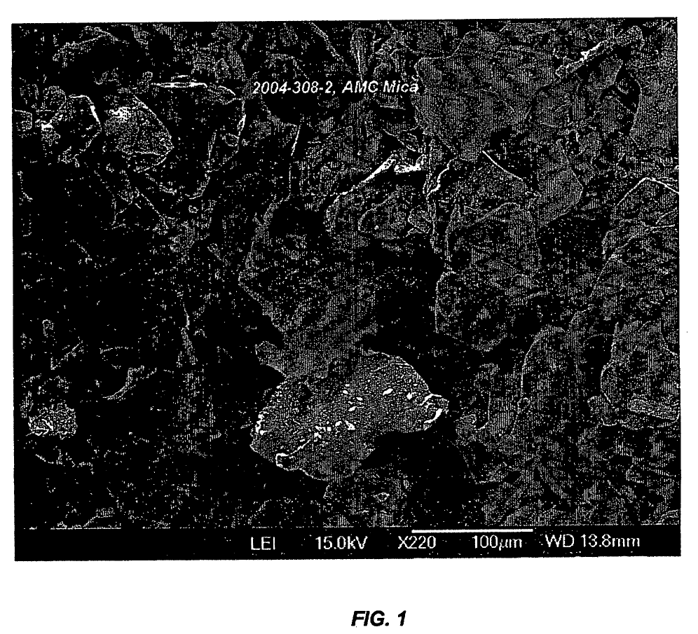

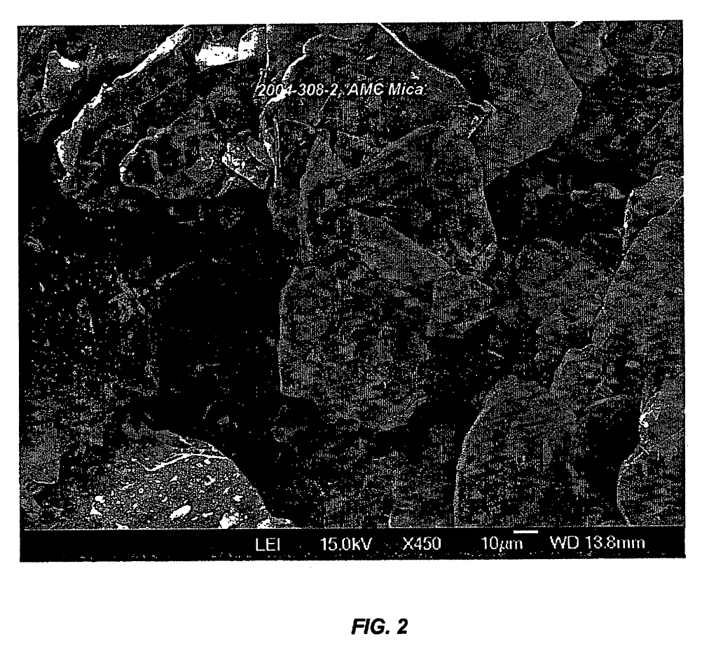

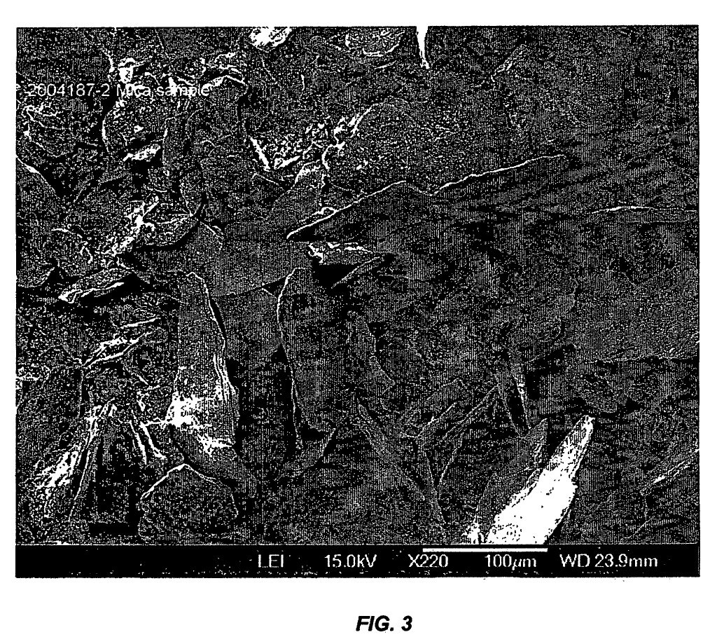

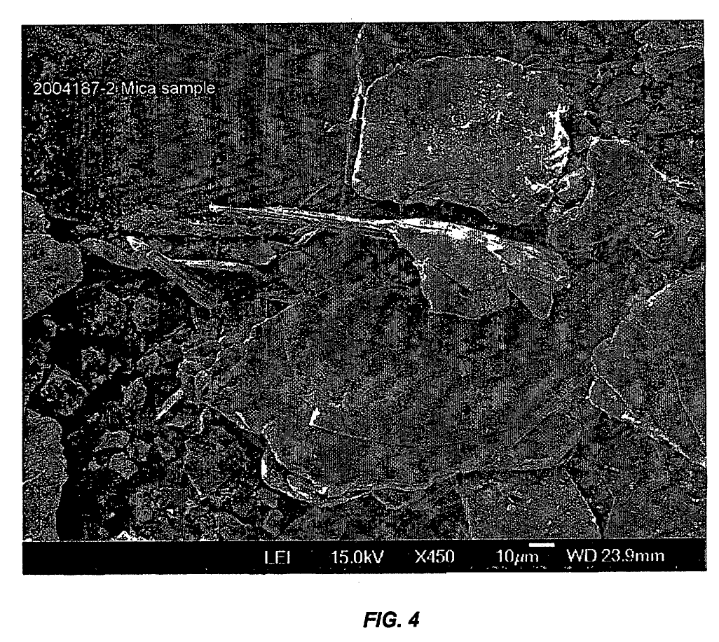

Samples of jet milled product and ball milled product were examined under scanning electron microscopy (SEM). FIGS. 1 and 2 are SEM photographs of a prior art jet-milled micaceous sample at 220 and 450× magnification, respectively. FIGS. 3 and 4 are SEM photographs of an inventive ball-milled micaceous sample at 220 and 450× magnification, respectively. The SEM photos show that the jet milled product has a more roughened surface relative to that of the ball milled product, which is indicative of hydrophobicity.

Heat treatment did not appear to influence hydrophobicity. AMC mica was not dried prior to milling whereas USG was dried prior to milling. Both AMC and USG ground mica, however, were hydrophobic.

Thus, hydrophobicity appeared to be affected by milling type only, and was not significantly influenced by heat treatment or grit content. A ball milled product was hydrophilic while jet milled product was hydrophobic. A burnish milled jet milled product in a mortar and pestle increased brightness and also converted the product from hydrophobic to hydrophilic; burnish milling the ball milled product in a mortar and pestle had no effect on brightness or hydrophobicity. Burnish milling is a light attrition milling that is performed for the purpose of smoothing surface irregularities.

### Example 4

### Effect of Heat Treating on Brightness

This Example describes experiments to determine the effect of heat treating mica on the resulting brightness.

Table IV lists data for Unmilled samples that had been subjected to various heat treatment processes. The grit content of these samples was also controlled to have either 0% by weight grit or 50% by weight grit.

TABLE IV
Heating Effect on Brightness

| | | | | | | Hydro- |
|---|---|---|---|---|---|---|
| Sample | Sample | Dry | Grit | | Bright- | phobic |
| ID No. | Description | Method | Percent | APS | ness | Yes/No |
| 11 | Unmilled | Air | 0 | | 52.1 | No |
| | mortar/pestle | | | | | |
| 9 | Unmilled | 100° C. | 0 | | 55.5 | No |
| | mortar/pestle | | | | | |
| 18 | Unmilled | 200° C. | 0 | | 49.1 | No |
| | mortar/pestle | | | | | |
| 12 | Unmilled | Air | 50 | | 58.6 | No |
| | mortar/pestle | | | | | |
| 10 | Unmilled | 100° C. | 50 | | 63.0 | No |
| | mortar/pestle | | | | | |
| 20 | Unmilled | 200° C. | 50 | | 60.7 | No |
| | mortar/pestle | | | | | |
| 13 | Unmilled | Air | 50 | | 60.5 | No |
| | mortar/pestle | | | | | |
| | (twice) | | | | | |
| 14 | Unmilled | 100° C. | 50 | | 59.9 | No |
| | mortar/pestle | | | | | |
| | (twice) | | | | | |
| 15 | Unmilled | 200° C. | 50 | | 51.0 | No |
| | mortar/pestle | | | | | |
| | (twice) | | | | | |

According to the data of Table IV, Samples 9 and 11 (the mica dried at 100° C.) was brighter than the air dried mica. Similarly, Samples 10 and 12 both contained 50% by weight grit and the mica dried at 100° C. was once again brighter than the air dried mica. However, once the product was milled, heat treating had no effect on brightness (compare samples 13, 14 and 15). In fact, heating the mica to 200° C. caused a slight reduction in brightness and heating to 500° C. actually turned the product brown, which reduced brightness. Mica dried at 100° C. was 5% brighter than air dried mica regardless of the grit content.

It can be seen from the Examples that brightness was affected by grit content, drying method and milling. The brightest mica was obtained by controlling grit at as high of a level permissible, drying at elevated temperature no higher than 100° C. prior to milling and ball milling the mica instead of jet milling. Ball milling the mica also produced a final product that was hydrophilic.

Other aspects of the invention will be apparent to those skilled in the art from consideration of the specification and practice of the invention disclosed herein. It is intended that the specification and examples be considered as exemplary only, with a true scope and spirit of the invention being indicated by the following claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

Unless otherwise indicated, all references herein to % weight of a material refers to the % weight on a dry basis of the cited material present in the relevant composition.

What is claimed is:

1. A method of processing micaceous material, comprising:
dry attrition grinding a micaceous material to produce a micaceous product having a particle size distribution such that at least about 60% by weight of the micaceous product passes through a 325 mesh screen.

2. The method according to claim 1, wherein the dry attrition grinding comprises dry media grinding.

3. The method according to claim 1, wherein the dry attrition grinding comprises mill grinding with a non-metallic media.

4. The method according to claim 3, wherein the non-metallic media comprises ceramic media.

5. The method according to claim 1, wherein the dry grinding comprises grinding with a ball mill.

6. The method according to claim 5, wherein the dry grinding comprises grinding with a ceramic ball mill.

7. The method according to claim 1, wherein the micaceous material comprises Spruce Pine mica.

8. The method according to claim 1, wherein the micaceous material is derived from a granitic rock.

9. The method according to claim 1, wherein the micaceous material is derived from at least one mineral chosen from alaskite and pegmatite.

10. The method according to claim 9, wherein the micaceous material is derived from alaskite, and is obtained by a process comprising separating the mica from feldspar by flotation.

11. The method according to claim 1, further comprising drying the micaceous material prior to the dry attrition grinding.

12. The method according to claim 11, wherein the drying comprises air drying.

13. The method according to claim 11, wherein the drying comprises heating the micaceous material at a temperature of at least about 35° C.

14. The method according to claim 13, wherein the drying comprises heating the micaceous material at a temperature ranging from about 35° C. to about 125° C.

15. The method according to claim 11, wherein the drying comprises heating with a fluid bed dryer.

16. The method according to claim 1, wherein the micaceous product has a particle size distribution such that about 80% by weight of the micaceous product passes through a 325 mesh screen.

17. The method according to claim 16, wherein the micaceous product has less than about 5% by weight +100 mesh oversize.

18. The method according to claim 17, wherein the micaceous product has less than about 3.5% by weight +100 mesh oversize.

19. The method according to claim 1, wherein the micaceous product is hydrophilic.

20. The method according to claim 1, wherein the micaceous product has an increased GE brightness over that of the micaceous material.

21. The method according to claim 20, wherein the micaceous product has a GE brightness of at least about 60.

22. The method according to claim 21, wherein the micaceous product has a GE brightness of at least about 65.

23. The method according to claim 1, wherein the micaceous product has a grit content ranging from about 0.1% to about 50% by weight, relative to the weight of the micaceous product.

24. The method according to claim 23, wherein the micaceous product has a grit content ranging from about 25% to about 50% by weight, relative to the weight of the micaceous product.

25. A method of processing micaceous material, comprising:
providing a micaceous material comprising Spruce Pine mica; and
dry grinding the micaceous material with a ceramic ball mill to obtain a micaceous product.

26. The method according to claim 25, further comprising drying the micaceous material prior to the grinding.

27. The method according to claim 26, wherein the drying comprises air drying.

28. The method according to claim 26, wherein the drying comprises heating the micaceous material at a temperature of at least about 35° C.

29. The method according to claim 28, wherein the drying comprises heating the micaceous material at a temperature ranging from about 35° C. to about 125° C.

30. The method according to claim 26, wherein the drying comprises heating with a fluid bed dryer.

31. The method according to claim 25, wherein the micaceous product has a particle size distribution such that about 60% by weight of the micaceous product passes through a 325 mesh screen.

32. The method according to claim 31, wherein the micaceous product has a particle size distribution such that about 80% by weight of the micaceous product passes through a 325 mesh screen.

33. The method according to claim 25, wherein the micaceous product has less than about 5% by weight +100 mesh oversize.

34. The method according to claim 33, wherein the micaceous product has less than about 3.5% by weight +100 mesh oversize.

35. The method according to claim 25, wherein the micaceous product is hydrophilic.

36. The method according to claim 25, wherein the micaceous product has an increased GE brightness over that of the micaceous material.

37. The method according to claim 36, wherein the micaceous product has a GE brightness of at least about 60.

38. The method according to claim 37, wherein the micaceous product has a GE brightness of at least about 65.

39. The method according to claim 25, wherein the micaceous product has a grit content ranging from about 0.1% to about 50% by weight, relative to the weight of the micaceous product.

40. A composition comprising a hydrophilic, dry-ground micaceous product having a particle size distribution such that at least about 60% by weight of the micaceous product passes through a 325 mesh screen.

41. The composition according to claim 40, wherein the dry-ground micaceous product has a particle size distribution such that about 80% by weight of the micaceous product passes through a 325 mesh screen.

42. The composition according to claim 40, wherein the micaceous product is dry-ground with at least one non-mica grinding media.

43. The composition according to claim 42, wherein the non-mica media is non-metallic.

44. The composition according to claim 43, wherein the non-metallic media comprises ceramic media.

45. The composition according to claim 40, wherein the dry-ground micaceous product is obtained from a micaceous material comprising Spruce Pine mica.

46. The composition according to claim 40, wherein the dry-ground micaceous product is derived from at least one mineral chosen from alaskite and pegmatite.

47. The composition according to claim 46, wherein the dry-ground micaceous product is derived from alaskite, and is obtained by a process comprising separating the mica from feldspar by flotation.

48. The composition according to claim 40, wherein the dry-ground micaceous product has less than about 5% by weight +100 mesh oversize.

49. The composition according to claim 48, wherein the micaceous product has less than about 3.5% by weight +100 mesh oversize.

50. The composition according to claim 40, wherein the dry-ground micaceous product has a GE brightness of at least about 60.

51. The composition according to claim 49, wherein the dry-ground micaceous product has a GE brightness of at least about 65.

52. The composition according to claim 40, wherein the dry-ground micaceous product has a grit content ranging from about 0.1% to about 50% by weight, relative to the weight of the micaceous product.

53. The composition according to claim 52, wherein the dry-ground micaceous product has a grit content ranging from about 25% to about 50% by weight, relative to the total weight of the micaceous product.

54. A paint comprising the composition of claim 40.

55. A composition comprising a dry-ground Spruce Pine mica having a GE brightness of at least about 60.

56. The composition according to claim 55, wherein the composition has a particle size distribution such that about 60% by weight of the mica passes through a 325 mesh screen.

57. The composition according to claim 56, wherein the composition has a particle size distribution such that about 80% by weight of the mica passes through a 325 mesh screen.

58. The composition according to claim 55, wherein the dry-ground Spruce Pine mica is dry-ground with at least one non-mica grinding media.

59. The composition according to claim 58, wherein the non-mica grinding media is non-metallic.

60. The composition according to claim 59, wherein the non-metallic media comprises ceramic media.

61. The composition according to claim 55, wherein the composition has less than about 5% by weight +100 mesh oversize.

62. The composition according to claim 61, wherein the micaceous product has less than about 3.5% by weight +100 mesh oversize.

63. The composition according to claim 55, wherein the dry-ground Spruce Pine mica is hydrophilic.

64. The composition according to claim 55, wherein the composition has a GE brightness of at least about 65.

65. The composition according to claim 55, wherein the composition has a grit content ranging from about 0.1% to about 50% by weight, relative to the total weight of the composition.

66. The composition according to claim 65, wherein the composition has a grit content ranging from about 25% to about 50% by weight, relative to the total weight of the composition.

67. A paint comprising the composition of claim 55.
